(19) United States
(12) Patent Application Publication
(10) Pub. No.: US 2004/0183913 A1
(43) Pub. Date: Sep. 23, 2004

(54) Portable photo-printer device accessory for a personal data assistant

(76) Inventor: Paul Grady Russell, Campbell, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/393,299

(22) Filed: Mar. 19, 2003

(51) Int. Cl. H04N 5/225; B41J 29/38

(52) U.S. Cl. 348/207.2; 348/373

(57) ABSTRACT

A method and apparatus for providing a portable electronic device configured to provide a picture image on a card. The portable electronic device includes a casing having a slot configured to receive a business card therein. The casing also includes a digital camera portion and a printer portion. The digital camera portion is configured to digitally capture an image and the printer portion is configured to print the image on a surface of the business card.

### BACKGROUND OF THE INVENTION

1. Field of the Invention

The present invention relates generally to portable electronic devices. More particularly, the present invention relates to a portable photo-printer device accessory for a personal data assistant.

2. Background of the Invention

People generally have a difficult time remembering intangible things such as dates, numbers and names. They tend to do better at making memory associations having visual components. For example, it may be easier to recall the details from a scene in a movie than the title of the movie. Many popular memory techniques take advantage of this by teaching students to associate those things they find difficult to remember, such as names and numbers, with a visual image. By doing this, the intangible thing is made visual, thus rendering it easier to remember.

This memory problem is nowhere more apparent than in face-to-name recognition. It is a general problem for people when they see an individual they have just met or are only slightly acquainted with to remember their name. In many cases, details concerning the individual can be recalled but the name remains elusive. People tend to find it is easier to remember details about an individual when associated with their face than to remember those same details associated with the individual's name.

This is a tremendously important issue in business settings due to the critical nature of establishing new contacts with individuals in related areas of business. These contacts bring new opportunities to strengthen a business and allow it to thrive. When a business individual meets a potential contact for the first time, impressions are made which are generally associated with the face of the contact, not the contact's name. The contact will usually then present the individual with a business card, containing information concerning the name, address and phone number of the contact. But many people have a difficult time associating the face and the first impression with the name on the card. In large professional meetings where literally hundreds of contacts can be made, this task becomes impossible. In these situations, opportunities from excellent contacts can be lost amongst the mediocre ones due to sheer volume.

Additionally, people tend to react negatively when their name and other details about them are not remembered by others. In a business setting, a bad impression can be generated by forgetting a contact's name, thus decreasing the potential opportunity derived from the association to the business. On the other hand, a positive reaction from a contact can greatly increase the probability of a successful interaction.

### SUMMARY OF THE INVENTION

The present invention relates to a method and apparatus for providing a portable electronic device configured to provide a picture image on a card. The portable electronic device includes a casing having a slot configured to receive a business card therein. The casing also includes a digital camera portion and a printer portion. The digital camera portion is configured to digitally capture an image and the printer portion is configured to print the image on a surface of the business card.

### BRIEF DESCRIPTION OF THE DRAWINGS

FIG. 1 illustrates a simplified, exploded perspective view of a portable electronic device, a personal data assistant and an ink cartridge unit in disengaged positions;

FIG. 2 illustrates a simplified, cross-sectional view of the portable electronic device engaged with the personal data assistant and the ink cartridge unit, depicting a business card in a printing position within the portable electronic device;

FIG. 3 illustrates a simplified schematic of the portable electronic device, the portable computer device and the ink cartridge unit;

FIG. 3(a) illustrates a simplified schematic of another embodiment of the portable electronic device;

FIG. 4 illustrates, in flow chart form, an embodiment by which the portable electronic device can be implemented by a user; and

FIG. 5 illustrates, in flow chart form, a continuation of FIG. 4.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

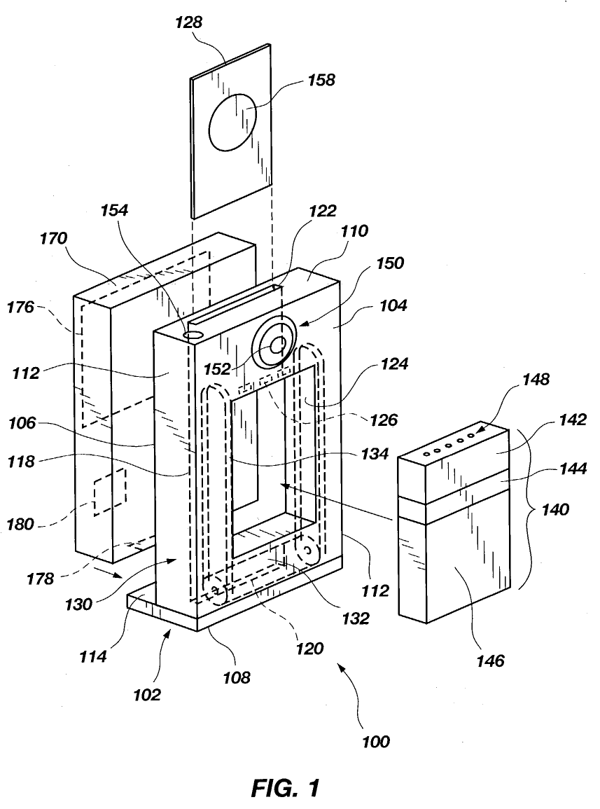

FIG. 1 illustrates a portable electronic device 100, an ink cartridge unit 140 and a personal data assistant (“PDA”) 170 disengaged from each other. The portable electronic device 100 is configured to interconnect and electrically communicate with the PDA 170. PDA's are well known in the portable electronic arts. The PDA 170 used in conjunction with the portable electronic device 100 can be any suitable, hand-held, battery powered information handling system such as an electronic address book or personal digital assistant. The exterior of the PDA 170 typically includes a display 176 (shown in outline), PDA terminals 178 (shown in outline) and various user input controls 180 (shown in outline). The display 176 is typically a touch-sensitive display, which can be a color display or mono-chrome display, but can be any type of display suitable for displaying information, still images, and real-time field-of-view images. The input controls 180 can be input buttons to input commands functioning with a user interface viewable on the display 176 of the PDA 170. It is also typical for the input controls 180 to be integrated with the touch-sensitive display 176 so the user inputs commands by directly depressing points in the display 176 with, for example, a wand. The PDA terminals 178 are generally configured for downloading and uploading data therethrough and powering a battery in the PDA 170. Such battery in the PDA 170 can be utilized to power an accessory device through the PDA terminals 178, such as the portable electronic device 100.

The portable electronic device 100, with the ink cartridge unit 140 attached therewith, is configured to provide a picture image 158 on a business card 128. The portable electronic device is configured to include a printer portion 130 and a digital camera portion 150. The digital camera portion 150 is configured to digitally capture a picture image 158, which can be viewed on the display 176 of the PDA 170. The printer portion provides means for receiving a business card 128 and printing the picture image 158 on a surface of the business card 128.

The small, compact and portable nature of the portable electronic device 100 enables a user to readily have the device 100 on demand along with the PDA 170. Such a device 100 can be useful in a business type setting. For example, the user can, upon meeting a potential business contact, or the like, take a picture image of the potential business contact and print such picture image directly to the business contact's business card. In this manner, the portable electronic device 100 provides the user with a means to facilitate the user's memory association of a business contact's face with their name and business information by immediately placing the picture image of the contact's face on their business card. Such can provide a favorable impression with the potential business contact and, more importantly, enhances the ability of the user to remember who the business contact is in association with their contact information on their business card for future reference. This can be a tremendous help when faced with numerous potential business contacts and their business cards when attending, for example, a convention or conference, or the like.

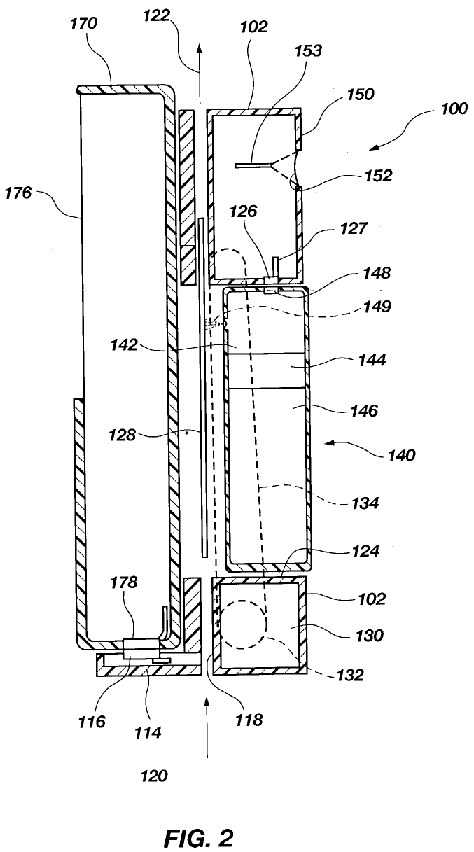

FIG. 2 illustrates a simplified cross-sectional view taken along line 2 in FIG. 1 of the portable electronic device 100 with the PDA 170 and cartridge unit 140 engaged with the device 100 and with a business card 128 in a printing position in the device 100. With reference to FIGS. 1 and 2, the portable electronic device 100 includes a casing 102 with the printer portion 130 and the digital camera portion 150 defined therein. The casing 102 can be generally rectangular in shape with a front side 104, a back side 106, a bottom side 108, a top side 110 and side surfaces 112. The casing 102 can be made from a polymeric type material, or any other suitable type material. The material employed for the casing can be made to substantially protect the device 100 from, for example, accidental drops or thermal type stresses.

The casing 102 includes a slot 118 defined therein, which is sized and configured to receive a business card 128. For example, a standard business card is about two inches wide, so the slot opening can be slightly wider, such as 2⅛ inches wide. However, the size of the slot can be larger or smaller, depending on the standard size of business cards in its area of use. The slot 118 can extend from a card input 120 at the bottom side 108 to a card output 122 at the top side 110 of the casing 102. In another embodiment, the slot 118 can extend through the casing 102 from the right and left side surfaces 112 of the casing 102. In still another embodiment, the slot 118 can extend partially into the casing so that the card is inserted and extracted from the same location.

The casing 102 also can include a cartridge opening 124 sized and configured to receive the ink cartridge unit 140. The cartridge opening 124 can extend through the casing 102 from the front side 104 to the back side 106. In another embodiment, the cartridge opening 124 can extend from the front side 104 to the slot 118 defined in the casing 102. In either case, the cartridge opening 124 extends at least to the slot 118 defined in the casing 102 so that a surface of the business card 128, when in a printing position within the portable electronic device, is exposed to the ink cartridge unit 140 when positioned in the cartridge opening 124.

The cartridge opening 124 includes terminals 126 on one of the surfaces defining the cartridge opening 124. Such terminals 126 are configured to correspond and mate with cartridge terminals 148 formed on the ink cartridge unit 140. It is through the terminals 126 that the portable electronic device 100 and PDA 170 electrically communicate information to the ink cartridge unit 140.

The casing 102 also includes connection terminals 116 configured to correspond and interconnect with PDA terminals 178 exposed on the PDA 170. Such casing 102 illustrates the connection terminals 116 as being formed on a ledge 114. Such a ledge 114 can be configured to extend from a bottom side 108 of the casing 102 and functions to support the PDA and maintain the interconnection between the portable electronic device 100 and the PDA 170. However, the casing 102 can include other means for supporting the PDA, such as the ledge 114 with side walls extending from the side surfaces 112 of the casing 102 to allow the PDA 170 to slidingly align and be positioned to match the PDA terminals 178 to the connection terminals 116. In either case, the connection terminals 116 provide a means for electrical communication between the portable electronic device 100 and the PDA 170. More particularly, it is through the connection terminals 116 that the portable electronic device 100 and PDA 170 can electrically communicate and transfer data, including digital images from the digital camera portion 150. Likewise, the portable electronic device 100 can be powered by the PDA 170 through the connection terminals 116. It is also contemplated that the portable electronic device can be powered from its own power source (not shown), such as a battery, which can be chargeable through the connection terminals 116.

As previously indicated, the casing 102 includes a printer portion 130. The printer portion 130 includes a drive unit 132 coupled to a belt member 134. The drive unit 132 is configured to drive the belt member 134. The drive unit 132 and belt member 134, in combination, are configured to move and position a business card 128 within the casing 102 to a printing position as well as extract the business card 128 from the casing 102. The belt member 134 can include two belts which can be adjacently positioned in the casing 102 to extend at least partially along longitudinal sides of the slot 118. With this arrangement, at least portions of the belt member 134 can be in contact with a portion of a surface of the business card 128 to control and manipulate the card 128 to the printing position and then to extract the card 128 from the casing 102.

The printer portion 130 of the portable electronic device 100 is configured to act in conjunction with the ink cartridge unit 140. The ink cartridge unit 140 can be sized and configured to be inserted and positioned in the cartridge opening 124 in the casing 102. The ink cartridge unit 140 is configured as a compact unit that is replaceable. The ink cartridge unit 140 can include a print head portion 142, an ink supply portion 144 and an ink storage portion 146. The ink cartridge unit 140 and the printer portion can be configured to be a thermal ink-jet or bubble jet printer, or any other suitable type of compact printer known in the art, such as a piezoelectric type printer. Such ink cartridge and printer technology is well known and can be implemented by one of ordinary skill in the art.

The ink cartridge unit 140 includes cartridge terminals 148 exposed on a surface of the unit 140 for electrically receiving information and signals from the terminals 126 of the portable electronic device 100. The cartridge terminals 148 receive the information from the PDA 170 through conductive traces 127 in the portable electronic device 100, which prompts and directs the print head portion 142 to print a specified picture image 158. The print head portion 142 receives ink from the ink supply portion 144, which in turn, receives ink from the ink storage portion 146 of the ink cartridge unit 140. The print head portion 142 is configured to print a picture image 158 by spraying multiple dots of ink, as known in the art, which collectively provide the picture image 158. As such, the ink cartridge unit 140 acts in conjunction with the printer portion 130, both of which function in accordance to signals communicated in the portable electronic device 100 and through the terminals 126 to the ink cartridge unit 140 to print the picture image 158.

As previously indicated, the casing 102 also includes a digital camera portion 150 which is configured to operate in conjunction with the PDA 170. The digital camera portion 150 can be activated by an activation switch 154. The digital camera portion includes a lens 152 for capturing a digital image which can be translated through conductive lines 153 and viewable on the display 176 of the PDA 170. Such digital image can be viewable as a real-time field-of-view image and/or a still image after, for example, snapping a picture with the digital camera portion 150. As digital camera technology is known, the digital camera portion 150 can readily be implemented by one of ordinary skill in the art.

With the previously described arrangement of the portable electronic device 100, a business card 128 can be inserted into the slot 118 at the card input 120 in the casing 102 and positioned to a printing position. At the printing position, the printer head provides an ink spray 149, or rather dots of ink, which is sprayed over a surface of the business card. The printer head portion 142 sprays the multiple dots of ink over a row. Once a row is completed, the printer portion 130 then incrementally moves the business card upward, via the drive unit 132, so that the printer head portion 142 can complete another row. This process is repeated until the picture image 158 previously taken by the digital camera portion 150 is printed onto the surface of the business card 128. The card 128 is then extracted from the card output 122 of the slot 118.

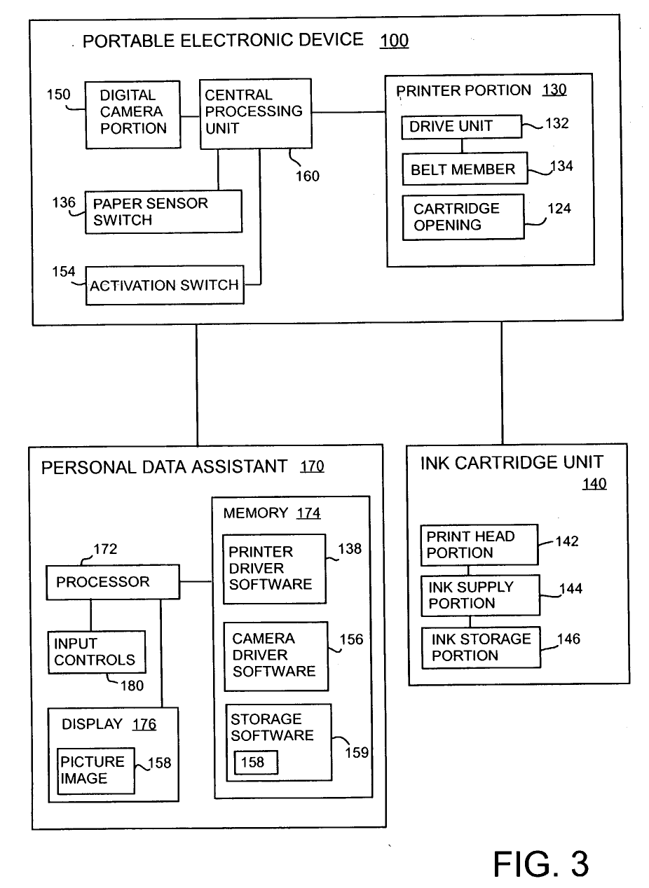

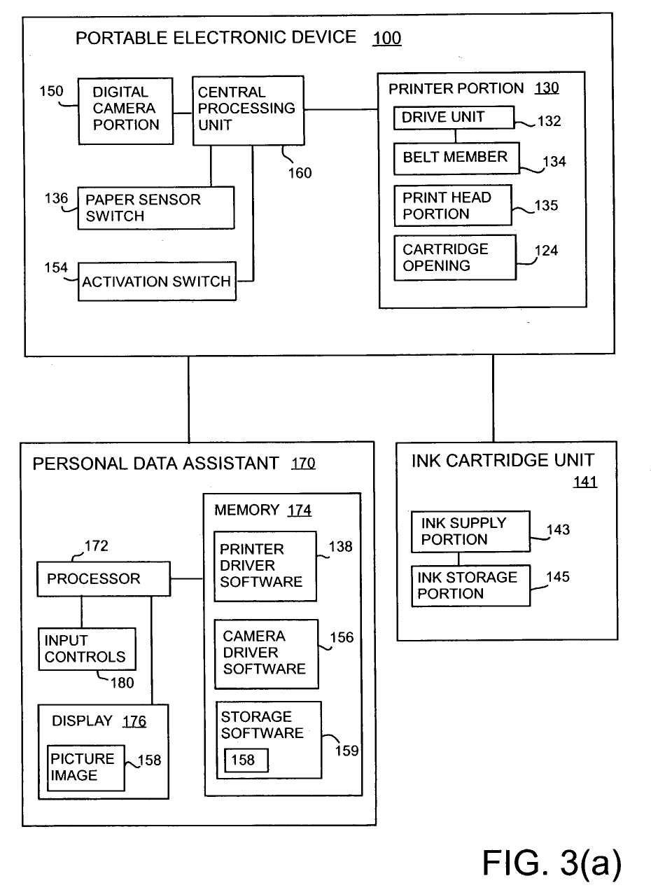

FIG. 3 illustrates a schematic of the portable electronic device 100, the PDA 170 and the ink cartridge 140. As depicted, the portable electronic device 100 includes a central processing unit 160. The central processing unit 160 is electrically interconnected to and configured to control and the various components of the portable electronic device 100. Such unit 160 is electrically interconnected to the printer portion 130 and the digital camera portion 150. The central processing unit 160 can also be interconnected with a paper sensor switch 136 and the activation switch 154. The activation switch 154 is configured to activate the portable electronic device 100. The paper sensor switch 136 is configured to sense the entry of the business card 128 and then activate the drive unit 132. The drive unit 132 then drives the business card to the printing position as previously described.

Referring to FIGS. 2 and 3, the casing 102 is configured to interconnect with and support the PDA 170. The PDA 170 includes, among other things, a processor 172, memory 174, the display 176 and input controls 110. As previously described, the portable electronic device is interconnectable with the PDA 170 so that PDA terminals 178 are in direct contact with connection terminals 116 formed in the portable electronic device 100.

The PDA 170 can include printer driver software 138, camera driver software 156 and storage software 159 loaded and stored in the memory 174 of the PDA. The printer driver software 138 and the camera driver software 156 function to communicate and drive the printer portion 130 and digital camera portion 150 of the portable electronic device 100, respectively. Both the printer driver software 138 and the camera driver software 156 provide a user interface to allow a user to input commands to control and prompt the respective printer portion 130 and the digital camera portion 150 of the portable electronic device 100.

With the printer driver software 138 and camera driver software 156 loaded on the PDA 170, the portable electronic device 100 can properly function in conjunction with the PDA 170. The portable electronic device 100 can be activated by depressing the activation switch 154. Once activated, the digital camera portion 150 digitally captures a digital image with respect to the orientation of the lens 152 of the digital camera portion 150. Such digital image can be a real-time field-of-view image, which can be viewed by a user on the display 176 of the PDA 170 via the interface of the camera driver software 156. The portable electronic device 100 can be oriented to a desired position, which position is viewable on the display 176 of the PDA 170. A picture can then be taken by, for example, depressing the activation switch 154, which digitally captures a picture image 158 also viewable on the display 176. As previously indicated, a business card 128 can then be inserted into the slot 118. The paper sensor switch 136 senses the business card 128 and activates the drive unit 132, which then pulls the business card 128 to a printing position with the drive belt 134. With the business card in printing position, the user can then prompt the printer portion 130 to print the picture image 158 on a surface of the business card 128 through an interface provided by the printer driver software 138. The printer driver software 138 then translates to signals to the ink cartridge unit 140 for printing the picture image 158. As the picture image 158 is being printed, the business card 128 is moved upward and is extracted from the slot 118 of the portable electronic device 100.

With reference to FIG. 3(a), another embodiment is illustrated in schematic form. This embodiment is substantially the same as that described in FIG. 3, except the ink cartridge unit does not include the print head portion. Rather, in this embodiment, the printer portion 130 includes a print head portion 135 integrated with the portable electronic device 100. The cartridge opening 124 can be sized and configured to receive an ink cartridge unit 141 having an ink supply portion 143 and an ink storage portion 145. Essentially, the portable electronic device 100 operates and functions the same as previously described, except since the print head portion 135 is integrated with the device 100, the ink cartridge opening 124 and ink cartridge unit 141 may be sized smaller. This embodiment may be utilized due to various factors such as the type of printer that may be employed. For example, it may be more advantageous to employ this embodiment with a piezoelectric type printer.

In another embodiment, the printer portion of the portable electronic device can be configured to receive an intermediate medium, such as a sticker or label. Such an intermediate medium can include a paper backing with a sticker portion that can be peeled from the paper backing. The intermediate medium can then be inserted into the slot, just as previously described for the business card, in which the printer portion can print the picture image onto the sticker portion. After printing, the intermediate medium can be extracted from the slot. Such picture image printed on the sticker portion can then be peeled from the intermediate medium and adhesively transferred to a surface of the business card.

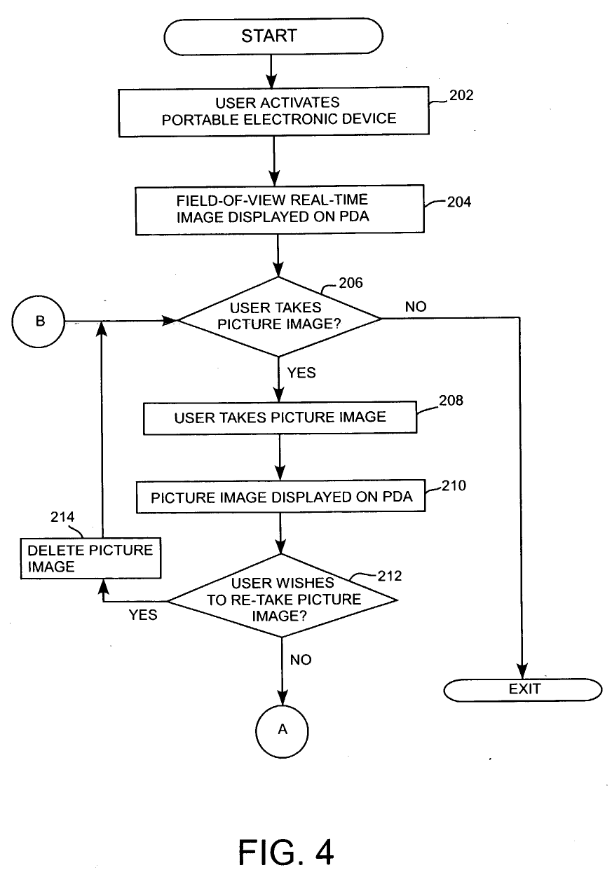

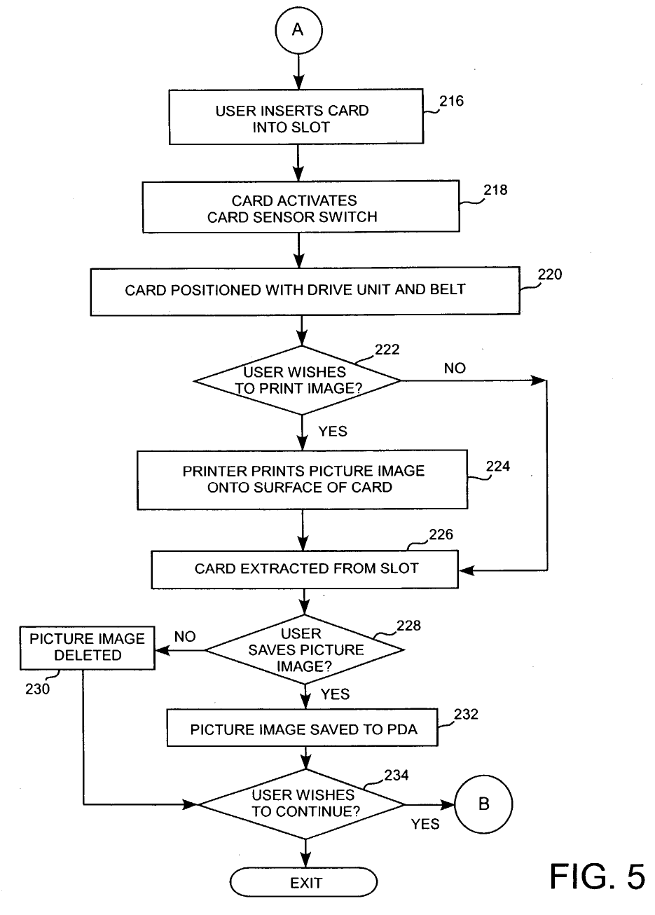

To better illustrate the functionality of the present invention, FIG. 4 illustrates a flow diagram of an embodiment by which the portable electronic device can be employed by a user in conjunction with the PDA and the ink cartridge. With reference to FIGS. 2, 3 and 4, as indicated by block 202, a user can activate the portable electronic device 100 by depressing the activation switch 154. Such activation also activates the digital camera portion 150, which digitally captures a real-time field-of-view image that is viewable on the display 176 of the PDA 170, as indicated in block 204. At this juncture, as indicated in user selection block 206, the user can either proceed by taking a picture image 158 or proceed by exiting by deactivating the portable electronic device 100. If the user wishes to take a picture image, the user proceeds to block 208. To take the picture image 158, the user can manipulate and orient the portable electronic device 100 to a desired position, which position is viewable on the display 176 as a real-time field-of-view image. Once the user has the desired position, the user can take the picture image. As indicated in block 210, the picture image is viewable on the display of the PDA. As indicated in user selection block 212, if the user is satisfied with the picture image 158, the user can proceed to block 216 (FIG. 5). If the user is not satisfied with the picture image 158, the user can proceed to block 214 and delete the picture image 158 and proceed to user selection block 206. The user can then proceed from user selection block 206 as previously described to take another picture image.

Once the user is satisfied with the picture image 158, the user proceeds to block 216 in FIG. 5. With reference to FIGS. 2, 3 and 5, as indicated in block 216, the user inserts a business card into the slot 118 defined in the casing 102. As the card is inserted, the card activates the paper sensor switch 136, as shown in block 218. The paper sensor switch 136 then prompts the drive unit 132, which drives the belt member 134 to move the card further into the slot 118 and position the card 128 to a printing position, as indicated in block 220. At this juncture, the user receives a prompt at the display 176 of the PDA 170, in which the user can choose whether to print, as indicated in user selection block 222. If the user wishes not to print, the card is extracted from the slot 118 via the drive unit 132 and belt member 134, as indicated in block 226. If the user wishes to print, the printer portion 130 in conjunction with the ink cartridge unit 140 proceeds to print the picture image 158 previously taken by the digital camera portion 150 onto a surface of the business card 158, as indicated in block 224. As the picture image is being printed and/or once the printing is complete, the card 128 is moved upward through the slot 118 and extracted therefrom.

As indicated in user selection block 228, the user can choose whether to save the picture image 158 as indicated in block 232 or delete the picture image as indicated in block 230. If the user wishes to save the picture image, the picture image is saved to the storage software 159 in the memory 174 of the PDA 170. If the user does not wish to save the picture image 158, the picture image 158 is deleted from the memory 174. At user selection block 234, the user can either exit by deactivating the portable electronic device or the user can return to user selection block 206 in FIG. 4. By returning to user selection block 206, the user can repeat the foregoing process of taking another picture image 158 and printing such picture image 158 on another business card 128.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth in the claims.

What is claimed is:

1. A portable electronic device configured to provide a picture image on a card, the device comprising:
a casing having a slot configured to receive a business card therein, said casing including:
a digital camera portion configured to digitally capture an image; and
a printer portion configured to print said image on a surface of the business card.

2. The portable electronic device of claim 1, wherein said printer portion comprises a drive unit configured to drive the business card into said casing and out of said casing.

3. The portable electronic device of claim 2, wherein said drive unit comprises a movement member configured to controllably receive the business card and extract the business card from said slot in said casing.

4. The portable electronic device of claim 1, further comprising an ink cartridge unit configured to be coupled with said printer portion in said casing.

5. The portable electronic device of claim 4, wherein said ink cartridge unit is insertable in said casing.

6. The portable electronic device of claim 4, wherein said ink cartridge unit comprises a print head portion configured to print said image on the surface of the business card.

7. The portable electronic device of claim 6, wherein said printer portion comprises a drive unit and a movement member driven by said drive unit, said drive unit configured to operatively move the business card as the print head portion prints said image on the surface of the business card.

8. The portable electronic device of claim 1, wherein said casing comprises a central processing unit configured to control said digital camera portion and said printer portion.

9. The portable electronic device of claim 8, wherein said central processing unit is interconnected to a sensor switch configured to sense a position of the business card.

10. The portable electronic device of claim 8, wherein said central processing unit is electrically interconnected to a connection port at least partially exposed on an external surface of said casing, said connection port configured to interconnect to a corresponding port of an external electronic device having a display portion.

11. The portable electronic device of claim 10, wherein said external electronic device comprises a personal data assistant.

12. The portable electronic device of claim 10, wherein said external electronic device includes printer driver software configured to operate with said printer portion.

13. The portable electronic device of claim 12, wherein said printer driver software is configured to facilitate a user interface through said display portion of said external electronic device, said user interface configured to facilitate user input controls to prompt operation of said printer portion.

14. The portable electronic device of claim 10, wherein said external electronic device includes camera driver software configured to operate said digital camera portion.

15. The portable electronic device of claim 14, wherein said camera driver software is configured to facilitate a user interface through said display portion of said external electronic device, said user interface configured to facilitate user input controls to prompt operation of said camera portion.

16. The portable electronic device of claim 10, wherein said display portion of said external electronic device is configured to display said image taken from said digital camera portion and configured to facilitate user input controls to prompt said camera portion and said printer portion.

17. A method of using an accessory device with a personal data assistant (“PDA”) for capturing a digital picture image and printing the digital picture image on a card, the method comprising:
electrically interconnecting a portable electronic device with the PDA, said portable electronic device having a casing with a slot configured to receive a business card therein, said casing including a digital camera portion and a printer portion;
capturing a picture image with said digital camera portion viewable on a display portion of the PDA;
positioning a business card in a printing position in said slot in said casing of said portable electronic device; and
printing said picture image onto a surface of said business card.

18. The method of claim 17, wherein said positioning comprises inserting said business card in said slot to be driven by a drive unit in said portable electronic device to said printing position.

19. The method of claim 17, wherein said capturing comprises displaying said picture image on a camera driver software interface viewable on the display portion of the PDA.

20. The method of claim 17, wherein said printing comprises prompting said printing through a printer driver software interface viewable on the display portion of the PDA.

21. The method of claim 17, further comprising interconnecting an ink cartridge unit to said casing of said portable electronic device.

22. The method of claim 21, wherein said printing comprises printing said picture image on said business card via said ink cartridge unit.

23. A portable electronic device having means for capturing a digital picture image and printing said digital picture image on a card, comprising:
digital picture means for digitally capturing a picture image; and
printing means for receiving a business card and printing said picture image on a surface of the business card.
